(19) United States
(12) Patent Application Publication
(10) Pub. No.: US 2004/0184704 A1
(43) Pub. Date: Sep. 23, 2004

(54) Curved metal-polymer dual-mode/function optical and electrical interconnects, methods of fabrication thereof, and uses thereof

(76) Inventors: Muhannad S. Bakir, Atlanta, GA (US); Kevin P. Martin, Atlanta, GA (US); James D. Meindl, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/699,230

(22) Filed: Oct. 31, 2003

Related U.S. Application Data
(60) Provisional application No. 60/455,362, filed on Mar. 17, 2003.
(60) Provisional application No. 60/498,419, filed on Aug. 28, 2003.

(51) Int. Cl. G02B 6/12

(52) U.S. Cl. 385/14

(57) ABSTRACT

Briefly described, embodiments of this disclosure, among others, include waveguide systems, methods of directing optical energy, input/output (I/O) interconnect systems, methods for fabricating an off-surface and curved optical waveguide, methods of aligning substrates, and methods of separating two microelectronic substrates. One exemplary waveguide system, among others, includes, a first substrate having an off-surface and curved optical waveguide disposed thereon.

### CROSS-REFERENCE TO RELATED APPLICATION

This application claims priority to co-pending U.S. provisional application entitled, “Surface Normal Curved Optical, Electrical, and RF-Input/Output Interconnections for Board/Package and Chip Level Interconnections” having Serial No.: 60/455,362, filed on Mar. 17, 2003, and co-pending U.S. provisional application entitled, “Input/Output Leads, Lithography and Nano-Indentations” having Serial No.: 60/498,419, filed on Aug. 28, 2003, which are entirely incorporated herein by reference.

### STATEMENT REGARDING FEDERALLY SPONSORED RESEARCH OR DEVELOPMENT

The U.S. government may have a paid-up license in this invention and the right in limited circumstances to require the patent owner to license others on reasonable terms as provided for by the terms of MDA awarded by the DARPA of the U.S. Government.

### TECHNICAL FIELD

This disclosure is generally related to integrated circuits, optoelectronics, photonics, and waveguides, and, more particularly, is related to devices having curved waveguides and interconnects, methods of fabrication thereof, and methods of use thereof.

### BACKGROUND

Conventional chip manufacturing is divided into front-end, back-end, and tail-end processing. Front-end of the line (FEOL) processing refers to the fabrication of transistors, while back-end of the line (BEOL) processing describes wafer metallization. Tail-end of the line (TEOL) processing refers to the packaging of the individual dice. Generally, the final wafer-level process step is the fabrication of vias through a passivation layer to expose the die pads, which serve as the interface between the die and the package. Each individual die, while still part of the wafer, is then functionally tested for wafer sort. The dice that pass this test are shipped to a packaging foundry where they are individually placed in a temporary package for burn-in. These dice are then individually packaged into their final package and tested again for functionality. This final step concludes tail-end processing and the functional packaged dice are ready for system assembly.

The mechanical performance of a package is important for wafer-level testing, protection, and reliability. Wafer-level testing of electrical devices requires simultaneous reliable electrical contact across a surface area. Typically, neither the wafer nor the testing substrate is planar enough to enable this reliable temporary electrical contact. In-plane (i.e., x-, y-axis) compliance is generally required to account for potential problems such as, for example, thermal expansion mismatch between the chip and printed wiring board and the probe contact leads. Wafer-level testing and burn-in demand significant out-of-plane (i.e., z-axis) compliance in order to establish reliable electrical contact between the pads on the non-planar wafer and pads/probes on the board surfaces. Non-compliance of the input/output (I/O) interconnects/pads out-of-plane, as well as in-plane (i.e., x-, y-axis), can cause difficulties in performing wafer-level testing and poor reliability. For optical interconnection, the alignment between the chip and the board should be maintained during field service to minimize optical losses due to offset.

A key interconnection level that will be severely challenged by gigascale integration (GSI) is the chip-to-module interconnection that integrates the packaged chip into the system. A gigascale system-on-a-chip (SoC) demands the development of new and cost-effective integrated input/output (I/O) interconnect solutions that use high-performance integrated electrical, optical, and radio frequency (RF) approaches to meet all of the I/O requirements of the 45 to 22 nm International Technology Roadmap for Semiconductors (ITRS) technology nodes (International Technology Roadmap for Semiconductors (ITRS), 2002 update, SIA). Meeting these challenges is essential for the semiconductor industry to transcend known limits on interconnects that would otherwise decelerate or halt the historical rate of progress toward GSI and beyond. In general, power, clock, and signal I/O functions will require the selective integration of fine pitch electrical (<30 μm pitch area array), optical, and RF I/O interconnect technologies. These high-density integrated I/O interconnects are needed for novel 3D structures as well as for high current (>400 A) and high bandwidth (>40 Tbs) applications. To solve the above issues it is required to overcome long-range and fundamental barriers in chip-to-module interconnects by advancing fine-pitch compliant interconnections, optoelectronic and RF interconnections, and wafer-level testing and burn-in.

Accordingly, there is a need in the industry to address the aforementioned deficiencies and/or inadequacies.

### SUMMARY

Briefly described, embodiments of this disclosure, among others, include waveguide systems, methods of directing optical energy, input/output (I/O) interconnect systems, methods for fabricating an off-surface and curved optical waveguide, methods of aligning substrates, and methods of separating two microelectronic substrates. One exemplary waveguide system, among others, includes, a first substrate having an off-surface and curved optical waveguide disposed thereon. The off-surface and curved optical waveguide includes a first portion and a second portion. The first portion is substantially parallel to the first substrate and the second portion extends curving away from the first substrate. The first portion has a first end, a second end, a length, a width, and a thickness. The second portion has a first end, a second end, a length, a width and a thickness. The second end of the first portion is substantially adjacent and in-line with the first end of the second portion. The first portion includes an optically conductive first material and the first portion includes an optically conductive second material.

Methods of directing optical energy are also provided. One exemplary method, among others, includes: providing a first substrate having an off-surface and curved optical waveguide disposed thereon, wherein the off-surface and curved optical waveguide includes a first portion and a second portion, wherein the first portion is substantially parallel to the first substrate, wherein the second portion extends curving away from the first substrate; and communicating optical energy through the first off-surface and curved optical waveguide.

I/O interconnect systems are also provided. One exemplary I/O interconnect system among others, includes: a first substrate and a second substrate. The first substrate includes a first off-surface and curved optical waveguide disposed thereon. The first off-surface and curved optical waveguide includes a first-portion and a second portion. The first portion is substantially parallel to the first substrate. The second portion extends curving away from the first substrate. The second portion includes a coupler layer selected from an optical coupler layer and a capacitive coupler layer, disposed on the second portion. The coupler layer is curved substantially the same as the first off-surface and curved optical waveguide. The second substrate has a second off-surface and curved optical waveguide disposed thereon. The second off-surface and curved optical waveguide includes a first portion and a second portion. The the first portion is substantially parallel to the first substrate and the second portion extends curving away from the first substrate. The second portion has a coupler layer selected from a optical coupler layer and a capacitive coupler layer, disposed on the second portion. The coupler layer is curved substantially the same as the second off-surface and curved optical waveguide. A top surface of the coupler layer of the first substrate and a top surface of the coupler layer of the second substrate are disposed adjacent one another and are communicatively coupled.

Methods of directing optical energy are also provided. One exemplary method, among others, includes: providing a first substrate having a first off-surface and curved optical waveguide disposed thereon, wherein the first off-surface and curved optical waveguide includes a first portion and a second portion, wherein the first portion is substantially parallel to the first substrate, wherein the second portion extends curving away from the first substrate, wherein the second portion has a coupler layer selected from a optical coupler layer and a capacitive coupler layer, disposed on the second portion, wherein the coupler layer is curved substantially the same as the first off-surface and curved optical waveguide; providing a second substrate having a second off-surface and curved optical waveguide disposed thereon, wherein the second off-surface and curved optical waveguide includes a first portion and a second portion, wherein the first portion is substantially parallel to the first substrate, wherein the second portion extends curving away from the first substrate, wherein the second portion has a coupler layer selected from an optical coupler layer and a capacitive coupler layer, disposed on the second portion, wherein the coupler layer is curved substantially the same as the second off-surface and curved optical waveguide, wherein a top surface of the coupler layer of the first substrate and a top surface of the coupler layer of the second substrate are disposed adjacent one another and are communicatively coupled; and communicating optical energy through the first off-surface and curved optical waveguide of the first substrate and the second off-surface and curved optical waveguide of the second substrate.

Methods for fabricating off-surface and curved optical waveguides are also provided. One exemplary method, among others, includes: providing a substrate; disposing a sacrificial material onto at least one portion of the substrate; disposing a stressed metal material onto a portion of the sacrificial material and a portion of the substrate; disposing a waveguide material onto a portion of the stressed metal material; and removing the sacrificial material.

Another exemplary method, among others, includes: providing a substrate; disposing a sacrificial material onto at least one portion of the substrate; disposing a waveguide material onto a portion of the sacrificial material and a portion of the substrate; disposing a stressed metal material onto a portion of the first material; and removing the sacrificial layer.

Another exemplary method, among others, includes: providing a substrate; disposing a waveguide material onto a curved mold and a portion of the substrate; and removing the mold.

Methods of aligning substrates are also provided. One exemplary method, among others, includes: providing a first substrate having an off-surface and curved optical waveguide disposed thereon, wherein the off-surface and curved optical waveguide includes a first portion and a second portion, wherein the first portion is substantially parallel to the first substrate, wherein the second portion extends curving away from the first substrate, wherein the first portion has a first end, a second end, a length, a width, and a thickness, wherein the second portion has a first end, a second end, a length, a width and a thickness, wherein the second end of the first portion is substantially adjacent and in-line with the first end of the second portion, wherein the first portion comprises an optically conductive first material, wherein the first portion comprises an optically conductive second material, and wherein the first substrate has a first coefficient of thermal expansion; and providing a second substrate having an optical element and having a second coefficient of thermal expansion, wherein the first coefficient of thermal expansion is different than the second coefficient of thermal expansion; and maintaining optical alignment between the first substrate and the second substrate.

Methods of separating two microelectronic substrates are also provided. One exemplary method, among others, includes: providing a first substrate having a sacrificial layer disposed on the first substrate, a stressed metal layer disposed on the sacrificial layer, and a structure disposed on the stressed metal layer; providing a second substrate, wherein the first substrate and the second substrate are bonded to one another on at least on position; assembling the first and second substrate; and removing the sacrificial layer, wherein upon removal of the sacrificial layer the stressed metal layer causes the structure to curve away from the first substrate and the movement of the structure causes the first substrate to move away from the second substrate.

Other systems, methods, features, and advantages of the embodiments described herein will be, or become, apparent to one with skill in the art upon examination of the following drawings and detailed description. It is intended that all such additional systems, methods, features, and advantages be included within this description, be within the scope of the embodiments described herein, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of this disclosure. Moreover, in the drawings, like reference numerals designate corresponding parts throughout the several views.

FIGS. 1A through 1F illustrate representative embodiments of off-surface and curved optical waveguides.

FIGS. 2A through 2C illustrate top views of three representative embodiments of the off-surface and curved optical waveguides.

FIGS. 3A and 3B illustrate cross-sectional views of two representative ways to implement the off-surface and curved optical waveguides shown in FIGS. 1A and 1B.

FIGS. 4A through 4C are cross-sectional views that illustrate a representative method of fabricating the off-surface and curved optical waveguide illustrated in FIG. 1A.

FIGS. 5A through 5D are cross-sectional views that illustrate a representative method of fabricating the off-surface and curved optical waveguide illustrated in FIG. 1C.

FIGS. 6A through 6D are cross-sectional views that illustrate a representative method of fabricating the off-surface and curved optical waveguide illustrated in FIG. 1E.

FIG. 7A is a cross-section of another representative embodiment of a funnel-shaped off-surface and curved optical waveguide, while FIGS. 7B and 7C are top views of two representative configurations of the off-surface and curved optical waveguide shown in FIG. 7A.

FIGS. 8A through 8D are cross-sections of a representative embodiment of forming a funnel shaped off-surface and curved optical waveguide.

FIG. 9 is a cross-section of a representative embodiment of an optical I/O interconnect system.

FIGS. 10A through 10C are cross-sections of a representative method for forming the optical I/O interconnect system shown in FIG. 9.

FIG. 11 is a cross-section of a representative embodiment of a dual optical/electrical I/O interconnect system.

FIGS. 12A through 12C are cross-sections of a representative method for forming the optical/electrical I/O interconnect system shown in FIG. 11.

FIG. 13 is a cross-section of a representative embodiment of a radio frequency (RF) I/O interconnect.

FIGS. 14A through 14C are cross-sections of a representative method, among others, for forming the RF I/O interconnect system shown in FIG. 13.

FIG. 15 is a cross-section of a representative embodiment of a multi-tiered off-surface and curved optical waveguide.

FIG. 16A is a top view of a structure having a representative polymer backbone lead, while FIG. 16B is a cross-section of the structure through the A-A cross-section shown in FIG. 16A.

FIGS. 17A through 17E are cross-sections of a representative method for forming the polymer backbone lead shown in FIGS. 16A and 16B.

### DETAILED DESCRIPTION

In general, off-surface and curved optical waveguides, optical input/output (I/O) interconnect systems, dual optical/electrical I/O interconnect systems, radio frequency (RF) I/O interconnect systems, polymeric backbone leads, methods of fabrication thereof, and methods of use thereof, are disclosed.

The types of devices that can use the off-surface and curved optical waveguides, optical I/O interconnect systems, dual optical/electrical I/O interconnect systems, RF I/O interconnect systems, polymeric backbone leads, include, but are not limited to, high speed and high performance chips such as, but not limited to, microprocessors, communication chips, and optoelectronic chips.

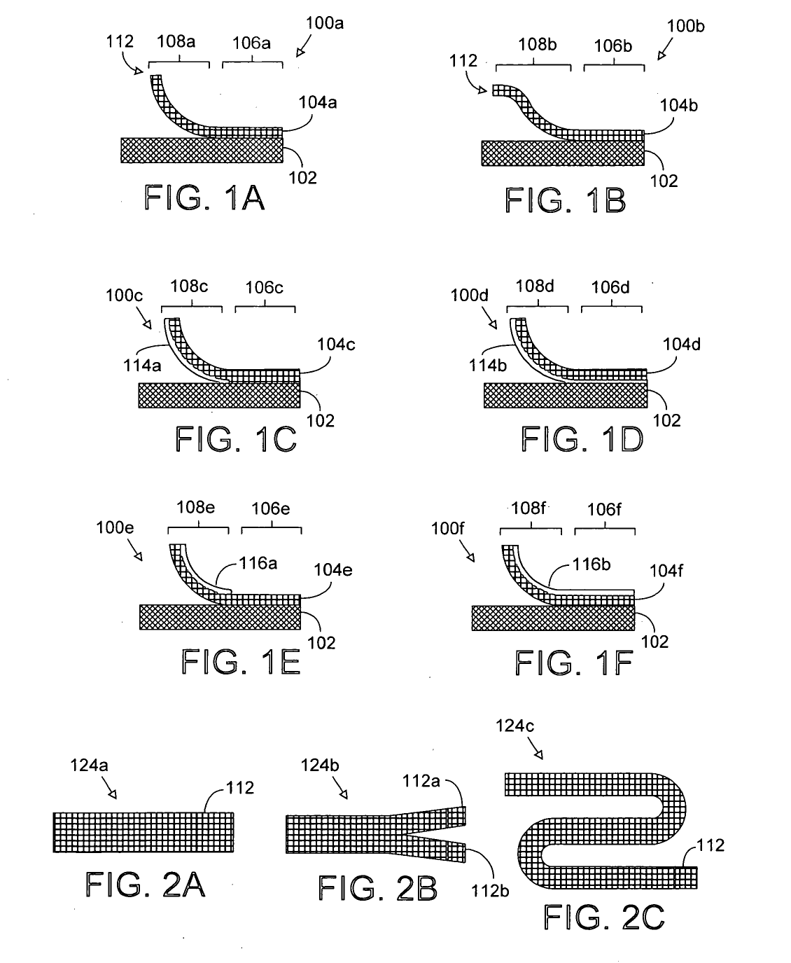

FIGS. 1A through 1F illustrate representative structures 100a-100f including off-surface and curved optical waveguides 104a-104f FIG. 1A illustrates an off-surface and curved optical waveguide 104a disposed on a first substrate 102. A first portion 106a of the off-surface and curved optical waveguide 104a is disposed substantially on the first substrate 102 and is substantially parallel to the first substrate 102. A second portion 108a of the off-surface and curved optical waveguide 104a curves up and away (e.g., curls) from the first substrate 102 so that the tip 112 is directed up and away from the first substrate 102. In another embodiment, among others, the off-surface and curved optical waveguide 104a, or a portion thereof, can be disposed within the first substrate 102.

The off-surface and curved optical waveguide 104a functions as a medium for optical energy to travel through. Therefore, the off-surface and curved optical waveguide 104a can be used to guide or route optical energy (e.g., light) between two parallel surfaces. In another embodiment, among others, the optical energy can be routed between two parallel surfaces without the use of optical coupling elements (e.g., gratings and mirrors) (FIG. 3A).

FIG. 1B illustrates another embodiment of the off-surface and curved optical waveguide 104b where the tip 112 is directed in the same plane as the first substrate 102 at an elevated height from the first substrate 102. In one embodiment, the tip 112 of the off-surface and curved optical waveguide 104b can be butt-coupled with another waveguide. In another embodiment, the tip 112 of the off-surface and curved optical waveguide 104b can include a grating or a mirror to direct the light into another waveguide or a detector located on a second substrate (FIG. 3B).

FIG. 1C illustrates another embodiment of the off-surface and curved optical waveguide 104c where a metal layer 114a is substantially disposed on a portion of the bottom side of the off-surface and curved optical waveguide 104c between the off-surface and curved optical waveguide 104c and the first substrate 102. The metal layer 114a is a stressed metal, which causes the second portion 108c of the off-surface and curved optical waveguide 104c to curve up and away from the first substrate 102, while the first portion 106c is substantially parallel to the first substrate 102. In addition, the tip 112 is directed up and away from the first substrate 102. In another embodiment, the tip 112 can be directed in other directions (e.g., in the same plane as the first substrate 102 at an elevated height from the first substrate 102).

FIG. 1D illustrates another embodiment of the off-surface and curved optical waveguide 104d where a metal layer 114b is substantially disposed on the entire bottom side of the off-surface and curved optical waveguide 104d between the off-surface and curved optical waveguide 104d and the first substrate 102. The metal layer 114b includes a stressed metal portion disposed adjacent and on the bottom side of a portion of the second portion 108d of the off-surface and curved optical waveguide 104d. The stressed metal portion of the metal layer 114b causes the second portion 108d of the off-surface and curved optical waveguide 104d to curve up and away from the first substrate 102, while the first portion 106d is substantially parallel to the first substrate 102. In addition, the tip 112 is directed up and away from the first substrate 102. In another embodiment, the tip 112 can be directed in other directions (e.g., in the same plane as the first substrate 102 at an elevated height from the first substrate 102).

FIG. 1E illustrates another embodiment of the off-surface and curved optical waveguide 104e where a metal layer 116a is substantially disposed on a portion of the top side of the off-surface and curved optical waveguide 104e on the side opposite the first substrate 102. The metal layer 116a is a stressed metal, which causes the second portion 108e of the off-surface and curved optical waveguide 104e to curve up and away from the first substrate 102, while the first portion 106e is substantially parallel to the first substrate 102. In addition, the tip 112 is directed up and away from the first substrate 102. In another embodiment, the tip 112 can be directed in other directions (e.g., in the same plane as the first substrate 102 at an elevated height from the first substrate 102).

FIG. 1F illustrates another embodiment of the off-surface and curved optical waveguide 104F where a metal layer 116b is substantially disposed on the entire top side of the off-surface and curved optical waveguide 104f on the side opposite the first substrate 102. The metal layer 116b includes a stressed metal portion disposed on topside of the off-surface and curved optical waveguide 104f. The stressed metal portion of the metal layer 116b causes the second portion 108f of the off-surface and curved optical waveguide 104f to curve up and away from the first substrate 102, while the first portion 106f is substantially parallel to the first substrate 102. In addition, the tip 112 is directed up and away from the first substrate. In another embodiment, the tip 112 can be directed in other directions (e.g., in the same plane as the first substrate 102 at an elevated height from the first substrate 102).

The first substrate 102 includes, but is not limited to, a chip, a high speed and high performance chip such as a microprocessor, communication chip, and optoelectronic chip, for example. In addition, the first substrate 102 can include additional components such as, but not limited to, die pads, leads, input/output components, waveguides, planar waveguides, polymer waveguides, optical waveguides having coupling elements such as diffractive grating couplers or mirrors disposed adjacent or within the optical waveguide, photodetectors, and optical sources such as VCSELS and LEDs.

For example, a second waveguide can be butt coupled to the off-surface and curved optical waveguide 104a-104f to guide optical energy from the second waveguide to the off-surface and curved optical waveguide 104a-104f. Alternatively, a coupling element can be disposed adjacent and/or within the second waveguide and/or the off-surface and curved optical waveguide 104a-104f to guide optical energy from the second waveguide to the off-surface and curved optical waveguide 104a-104f, or vice versa.

The first substrate 102 can be made of materials such as, for example, silicon, silicon compounds, germanium, germanium compounds, gallium, gallium compounds, indium, indium compounds, or other semiconductor materials and/or compounds. In addition, the first substrate 102 can include non-semiconductor substrate materials, including any dielectric material, metals (e.g., copper and aluminum), or ceramics or organic materials found in printed wiring boards, for example.

The off-surface and curved optical waveguide 104a-104f includes, but is not limited to, a waveguide core, one or more cladding layers substantially disposed on one or more sides of the waveguide core, one or more coupling elements (e.g., grating couplers and mirrors), and combinations thereof.

The waveguide core can be made of off-surface and curved optical waveguide materials (optically conductive materials). In general, materials that exhibit: (a) transparency to a particular optical wavelength of light, (b) process compatibility with other materials such that a contrast in refractive index is achieved, (c) process compatibility with standard microelectronic fabrication processes, (d) suitable mechanical strength, flexibility, and durability, and/or (e) sufficient lifetime and/or reliability characteristics, can serve as the off-surface and curved optical waveguide material. A reference describing polymer materials suitable for off-surface and curved optical waveguide applications can be found in A. R. Blythe and J. R. Vinson, Proc. 5^{th} International Symposium on Polymers for Advanced Technologies. Tokyo, Japan: pp. 601-11, August-December 2000, which is incorporated herein by reference.

In particular, the off-surface and curved optical waveguide 104a-104f can be made of a low modulus material such as, but not limited to, polyimides, epoxides, polynorbornenes, polyarylene ethers, and parylenes. In particular, the low modulus materials can include, but are not limited to, compounds such as, BCB, Amoco Ultradel™ 7501, Promerus™ LLC, Avatrel™ Dielectric Polymer, DuPont™ 2611, DuPont™ 2734, DuPont™ 2771, and DuPont™ 2555.

The cladding layer can be a material that has a lower index of refraction than the waveguide core, and these may include, for example, the same or similar materials as those employed for the waveguide core. Alternatively in another embodiment, the first substrate 102 can act as and/or contain the cladding layer.

The off-surface and curved optical waveguide material and the cladding layer material can be disposed using techniques such as, but not limited to, spin-coating, doctor-blading, sputtering, lamination, screen or stencil-printing, chemical vapor deposition (CVD), plasma based deposition, and combinations thereof.

Portions of the waveguide core of the off-surface and curved optical waveguide not bound by the cladding layer, the metal layers 114a, 114b, 116a, and 116b, or the first substrate 102 are surrounded by air, which acts as an air-gap cladding layer. The air cladding and the resulting high index of refraction difference (Δn) between the waveguide core of the off-surface and curved optical waveguide and the air-gap cladding has the benefit of confining the optical wave and thus minimizing crosstalk. Air-gap cladding also has two additional benefits when compared to non-air cladding in this application: 1) the off-surface and curved optical waveguide can guide an optical wave through larger bends (due to large Δn), which means higher compliance, and 2) the air-gap cladding does not impose any mechanical and/or physical constraints on the movement of the off-surface and curved optical waveguides or contain. Thus, air-gap cladding offers the lowest index of refraction possible and is the least mechanically resistant material. However, the off-surface and curved optical waveguides or contain may be passivated with any cladding material, if desired.

The off-surface and curved optical waveguide or contain can have a width from about 1 to 100 micrometers and a height of about 0.1 to 100 micrometers. In addition, the off-surface and curved optical waveguide or contain can have a length of about 10 to 1000 micrometers. In one embodiment, the first portion 106a-106f and the second portion 108a-108f can have the same width and/or height. In another embodiment, the first portion 106a-106f and the second portion 108a-108f can have different widths and/or heights. In still another embodiment, the width and/or heights can vary along the length of the first portion 106a-106f and the second portion 108a-108f (e.g., tapered).

The metal layer 114a, 114b, 116a, and 116b can include metals such as, but not limited to, gold, gold alloys, copper, and copper alloys, molybdenum/chromium combinations, refratory metals, and combinations thereof. The stressed metal portion can include metals such as, but not limited to, molybdenum/chromium combinations, gold deposited under different conditions and combinations thereof. The metal layer 114a, 114b, 116a, and 116b can be formed using techniques such as, but not limited to, sputtering techniques, electroplating techniques, and combinations thereof.

In embodiments including coupling elements, the types of coupling elements that can be used include, but are not limited to, planar (or volume) grating couplers, evanescent couplers, surface-relief grating couplers, total internal reflection couplers, mirrors, and combinations thereof. Additional details regarding grating couplers can be found in U.S. Pat. No. 6,285,813, which is herein incorporated by reference. The presence of coupling elements, however, is not a requirement for this technology, as simple butt-coupling of optical power both into and out of waveguides can be performed.

As indicated above, the off-surface and curved optical waveguide 104a-104f can receive optical energy from components located on or within the first substrate 102. The optical energy can then be guided through the off-surface and curved optical waveguide 104a-104f to a second substrate including, but not limited to, an optical detector, a coupling element, a waveguide, optical sources, and combinations thereof. For example, the optical energy guided by the off-surface and curved optical waveguide 104a-104f can be directed to an optical detector disposed on or within the second substrate. In another embodiment, a plurality of off-surface and curved optical waveguides 104a-104f can be incorporated into a board-level clock distribution network or optical distribution network. The endpoints of the clock or optical distribution network can be formed using the off-surface and curved optical waveguides 104a-104f.

In still another embodiment, among others, optical energy can be guided from a second substrate into the off-surface and curved optical waveguide 104a-104f disposed on the first substrate 102. The optical energy can be guided through the off-surface and curved optical waveguide 104a-104f to a second waveguide via butt-coupling or through the use of one or more coupling elements disposed adjacent or within the off-surface and curved optical waveguide 104a-104f and/or the second waveguide.

FIGS. 2A through 2C illustrate top views of three representative embodiments, among others, of off-surface and curved optical waveguides. FIG. 2A illustrates a rectangular off-surface and curved optical waveguide 124a having a single tip 112. In addition, the off-surface and curved optical waveguide 124a has a uniform width and thickness. The curve of the rectangular off-surface and curved optical waveguide 124a can include a single curved portion (FIGS. 1A through 1C), two or more curved portions and one or more planar portions (i.e., planar with the plane of the first substrate) (FIGS. 14A through 14C), or combinations thereof. In addition, the rectangular off-surface and curved optical waveguide 124a can have a tapered width and/or height.

FIG. 2B illustrates a “Y”-shaped off-surface and curved optical waveguide 124b having two tips 112a and 112b. Other embodiments of the off-surface and curved optical waveguide 124b can have three or more tips. The “Y”-shaped off-surface and curved optical waveguide 124b uniform has a uniform width and thickness. Off-surface and curved optical waveguides 124b having a plurality of tips can be used to receive and/or transmit optical energy to a plurality of sources and can function as a optical power splitter or adder. In addition, the curve of the “Y”-shaped off-surface and curved optical waveguide 124b can include a single curved portion (FIGS. 1A through 1C), two or more curved portions and one or more planar portions (i.e., planar with the plane of the first substrate) (FIGS. 14A through 14C), or combinations thereof. In addition, the “Y”-shaped off-surface and curved optical waveguide 124b can have a tapered width and/or height.

FIG. 2C illustrates an “S”-shaped off-surface and curved optical waveguide 124c having a single tip 112. In addition, the “S”-shaped off-surface and curved optical waveguide 124c has a uniform width and thickness. The curve of the “S”-shaped off-surface and curved optical waveguide 124c can be altered to be a series of “S”-shaped curves, a series of “U”-shaped curves, a coiled shaped curve, and combinations thereof. In addition, the curve of the “S”-shaped off-surface and curved optical waveguide 124c can include a single curved portion, a curved portion and a planar portion (i.e., planar with the plane of the first substrate), or a combination thereof. In addition, the “S”-shaped off-surface and curved optical waveguide 124c can have a tapered width and/or height. It should be noted that the degree of the radius of curvature not cause undue optical loss.

FIGS. 3A and 3B illustrate cross-sectional views of two representative ways to implement the off-surface and curved optical waveguides shown in FIGS. 1C and 1B. For example, FIG. 3A illustrates the off-surface and curved optical waveguide 104c and metal layer 144a disposed on a first substrate 102a. In addition, a second substrate 102b is disposed adjacent the first substrate 102a, wherein the second substrate 102b includes an optical detector 126. Optical energy is guided through the off-surface and curved optical waveguide 104c and is directed towards the optical detector, 126 (e.g., optical source and optical element).

This configuration enables the routing of an optical signal between two parallel surfaces without the use of any optical coupling devices, such as mirrors and grating couplers. Instead, the underlying metal film curls upward to mitigate chip access to the cross-section of the polymer waveguide for direct butt-coupling.

In particular, the off-surface and curved optical waveguide 104c can be fabricated on the printed wiring/waveguide board (PWWB). The off-surface and curved optical waveguide 104c can be directly bonded to an on-chip optical source or detector. Such an interconnection enables the use of a single polymer waveguide for board-to-chip optical communication. As a result, a single polymer waveguide on the PWWB is potentially all that it is needed to enable chip-to-chip optical communication. On the chip side, only optical sources and detectors are fabricated/hybrid integrated. As a result, this potentially minimizes the processing required on the board and on the chip because no mirrors and grating couplers are needed. In addition, the overall cost of the system is perhaps minimized because the chip and the PWWB are co-designed and co-optimized.

It should also be noted, that the off-surface and curved optical waveguide 104c can be directly incorporated into a board-level optical or clock distribution network. Following the fan-out distribution, it is possible to fabricate the endpoints of the optical or clock distribution network with the off-surface and curved optical waveguide 104c. Also, the off-surface and curved optical waveguide can have an air-cladding which decreases the tolerated radius of curvature. The optical losses associated with the off-surface and curved optical waveguide are potentially less than the optical losses associated with optical coupling elements, such as mirrors and gratings, which are needed for right-angle bends.

FIG. 3B illustrates an optical interconnect including an off-surface and curved optical waveguide 104b on a first substrate 102a having an optical coupler 128 (e.g., mirror) disposed on the end thereof. The optical coupler 128 couples to an optical element 126 disposed on the second substrate 102b. An optically compatible material can be used to make the permanent mechanical connection with the second substrate 102b. In addition, the first substrate 102a includes electrical solder 134 that couples to an electrical lead 132 disposed on a die pad 136 on the second substrate 102b.

The electrical leads are fabricated independent off the optical interconnections. The chip and board assembly takes place prior to the release of the electrical lead 132 (e.g., a stress-engineered metallic lead). Thus, the assembly takes place while the two surfaces are flat, which simplifies the assembly process. Once the electrical and optical interconnections are bonded to their respective locations, the release layer (not shown) is removed to cause the electrical lead 132 to spring off the surface of the second substrate 102b. Additional details regarding the release layer (sacrificial layer) are described below.

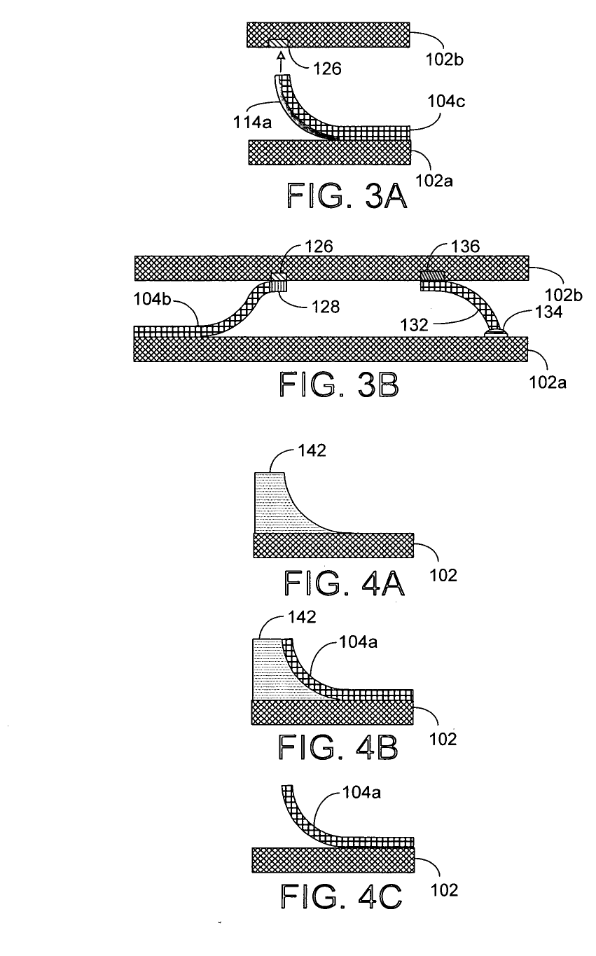

For the purposes of illustration only, and without limitation, the off-surface and curved optical waveguides 104a, 104c, and 104e are described with particular reference to the below-described fabrication method. For clarity, some portions of the fabrication process are not included in FIGS. 4A through 4C, 5A through 5D, and 6A through 6D. As such, the following fabrication process is not intended to be an exhaustive list that includes all steps required for fabricating the off-surface and curved optical waveguides 104a, 104c, and 104e. In addition, the fabrication process is flexible because the process steps may be performed in a different order than the order illustrated in FIGS. 4A through 4C, 5A through 5D, and 6A through 6D.

FIGS. 4A through 4C are cross-sectional views that illustrate a representative method of fabricating the off-surface and curved optical waveguide 104a illustrated in FIG. 1A. FIG. 4A illustrates the first substrate 102 having a curved mold 142 disposed thereon 142. The curved mold 142 can be made of material such as, but not limited to, polymers. The curved mold 142 can be formed by methods such as, but not limited to, wet and dry etching, photoimaging, and molding.

FIG. 4B illustrates the off-surface and curved optical waveguide 104a disposed on the curved mold 142. The off-surface and curved optical waveguide 104a can be defined by one or more methods such as, but not limited to, photo-definition, wet chemical etching, dry plasma etching, thermally-induced refractive index gradients, and ion implantation, depending upon the components included in the off-surface and curved optical waveguide (e.g., cladding layers and coupling elements). In addition, the formation of the off-surface and curved optical waveguide 104a can include multiple steps not illustrated here.

FIG. 4C illustrates the removal of the curved mold 142 to form the off-surface and curved optical waveguide 104a. The curved mold 142 can be removed by methods such as, but not limited to, plating, sputtering techniques, and other metal deposition techniques.

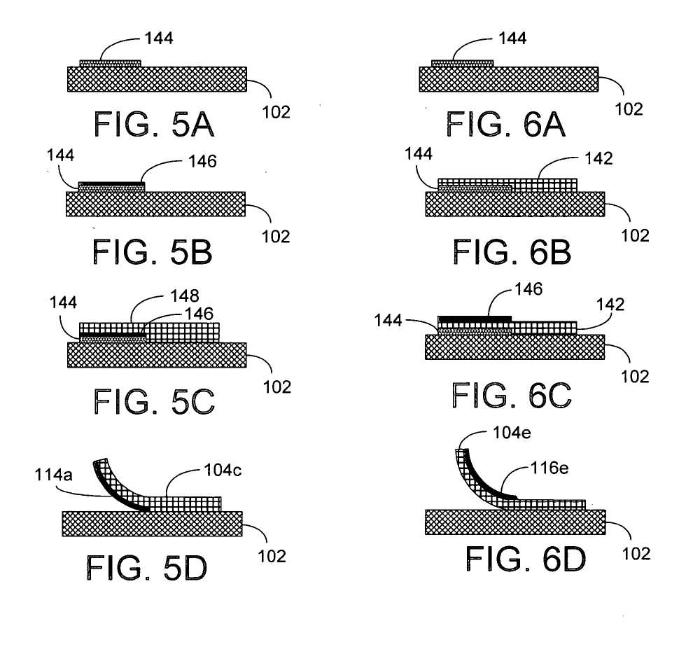

FIGS. 5A through 5D are cross-sectional views that illustrate a representative method of fabricating the off-surface and curved optical waveguide 104c illustrated in FIG. 1C. FIG. 4A illustrates the first substrate 102 having a sacrificial material 144 disposed thereon. In general, the sacrificial material 144 can be disposed on the first substrate 102 using methods such as, but not limited to, wet and dry etching, photoimaging, and molding. The sacrificial material 144 can include materials such as, but not limited to, polymers, metals, non-organic dielectrics (e.g., oxides and nitrides), thermally decomposable polymers, and combinations thereof.

FIG. 5B illustrates the formation of a metal layer 146 on the sacrificial material 144. The metal layer 146 can be formed of a stressed metal, which means that upon removal of the sacrificial material 144, the metal layer 146 curves up and away from the first substrate 102. The metal layer 146 can be formed by methods such as, but not limited to, plating, sputtering techniques, and other metal deposition techniques.

FIG. 5C illustrates the formation of a waveguide layer 148 upon the metal layer 146 and the first substrate 102. The waveguide layer 148 can be defined by one or more methods such as, but not limited to, photo-definition, wet chemical etching, dry plasma etching, thermally-induced refractive index gradients, and ion implantation, depending upon the components included in the waveguide layer (e.g., cladding layers and coupling elements). In addition, the formation of the waveguide layer 148 can include multiple steps not illustrated here.

FIG. 5D illustrates the formation of the off-surface and curved optical waveguide 104c upon the removal of the sacrificial layer 144. Once the sacrificial layer 144 is removed, the metal layer 146 disposed upon the sacrificial layer 144 curves up and away from the first substrate 102. The movement of the metal layer 146 causes the waveguide layer 148 to curve in substantially the same manner as the metal layer 114a to form the off-surface and curved optical waveguide 104c. The sacrificial layer 144 can be removed using techniques such as, but not limited to, wet etching, dry etching, photoimaging, molding, heating, deomposition, and combinations thereof.

It should also be noted that the removal (release) of the sacrificial material could be used to separate the first substrate from a second substrate. In other words, two parallel flat surfaces that are bonded to one another can be separated by releasing the sacrificial material. As shown in FIG. 3B above, one or more sacrificial material layers can be used on off-surface and curved optical waveguides and/or metal leads to separate two substrates bonded to one another.

FIGS. 6A through 6D are cross-sectional views that illustrate a representative method of fabricating the off-surface and curved optical waveguide 104e illustrated in FIG. 1E. FIG. 6A illustrates the first substrate 102 having a sacrificial layer 144 disposed thereon.

FIG. 6B illustrates the formation of a waveguide layer 142 upon the sacrificial layer 144 and a portion of the first substrate 102. The waveguide layer 142 can be defined by one or more methods such as, but not limited to, photo-definition, wet chemical etching, dry plasma etching, thermally-induced refractive index gradients, and ion implantation, depending upon the components included in the waveguide layer 142 (e.g., cladding layers and coupling elements). In addition, the formation of the waveguide layer 142 can include multiple steps not illustrated here.

FIG. 6C illustrates the formation of a metal layer 146 on top of a portion of the waveguide layer 142. The metal layer 146 can be formed of metals as described in reference to FIG. 5B.

FIG. 6D illustrates the formation of the off-surface and curved optical waveguide 104e upon the removal of the sacrificial layer 144. Once the sacrificial layer 144 is removed, the metal layer 146 disposed upon the waveguide layer 142 curves up and away from the first substrate 102. The metal layer 116e causes the waveguide layer 142 to curve in substantially the same manner to form the off-surface and curved optical waveguide 104e. The sacrificial layer 144 can be removed using techniques such as, but not limited to, wet etching, dry etching, photoimaging, molding, heating, deomposition, and combinations thereof.

It should also be noted that the removal (release) of the sacrificial material can be used to separate the first substrate from a second substrate. In other words, two parallel flat substrates that are bonded to one another can be separated by releasing the sacrificial material. As shown in FIG. 3B above, one or more sacrificial material layers can be used on off-surface and curved optical waveguides and/or metal leads to separate two substrates bonded to one another.

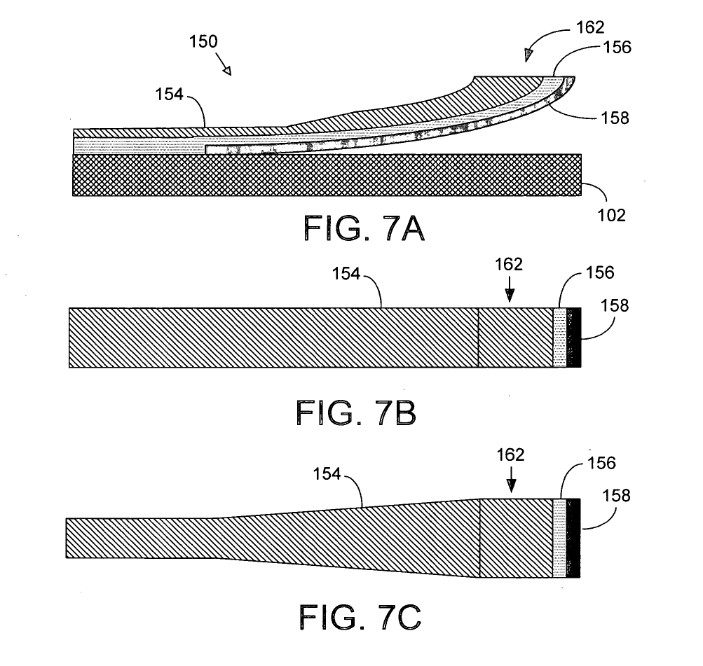

FIG. 7A is a cross-section of another representative embodiment, among others, of a funnel-shaped off-surface and curved optical waveguide 150 disposed on a first substrate 102. The funnel-shaped off-surface and curved optical waveguide 150 includes, but is not limited to, a waveguide 154 and a cladding layer 156. In addition, a stressed metal layer 158 is disposed on a portion of the bottom side of the off-surface and curved optical waveguide 150 between the cladding layer 156 and the first substrate 102.

The first substrate 102, the funnel-shaped off-surface and curved optical waveguide 150, the cladding layer 156, and the stressed metal layer 158 are similar (e.g., materials each are made of, fabrication thereof, and function thereof) to the corresponding components in 1A through 1F.

The thickness of the waveguide 154 increases moving from one end to the tip 162. The result of increasing the thickness is that the tip 162 of the waveguide 154 has a larger surface area to emit and/or receive optical energy. In other words, the increase in thickness and the curving of the waveguide 154 forms a funnel-shaped waveguide having a tip 162 with a larger surface area.

The funnel-shaped off-surface and curved optical waveguide 150 is advantageous because the larger surface area tip decreases optical losses due to butt coupling with an optical source or detector located on the second substrate. As a result, the large waveguide core cross-section at the tip 162 (e.g., chip end) mitigates the spatial requirements for low-loss optical butt-coupling. It may be desirable to make the cross-section of the funnel-shaped off-surface and curved optical waveguide 150 at the tip 162 to be slightly larger than the size of the detectors/sources (or mirrors/gratings) located on a second substrate to account for the alignment tolerances. The design of the funnel-shaped off-surface and curved optical waveguide 150 depends, at least in part, upon the radius of curvature of the lead from mechanical (compliance) and optical (waveguide) perspectives, core tapering, the indices of refraction of the core and cladding, the thickness of the cladding, for example.

More specifically, FIG. 7B illustrates a top view of an embodiment of a funnel-shaped off-surface and curved optical waveguide 150. In this embodiment, the width of the waveguide 154 are substantially the same. The height of the waveguide 154 is tapered from the first end to the tip 162, so that the tip 162 has a larger surface area than if the height of the tip 162 was the same as the height of the first end.

In contrast, FIG. 7C illustrates a top view of an embodiment of a funnel-shaped off-surface and curved optical waveguide 150 having varied widths. The height of the waveguide 154 is tapered from the first end to the tip 162. In addition, the width of the waveguide 154 increases moving from the first end to the tip 162. The surface area of the tip 162 is increased by increasing the width and the height of the tip 162 of the funnel-shaped off-surface and curved optical waveguide 150.

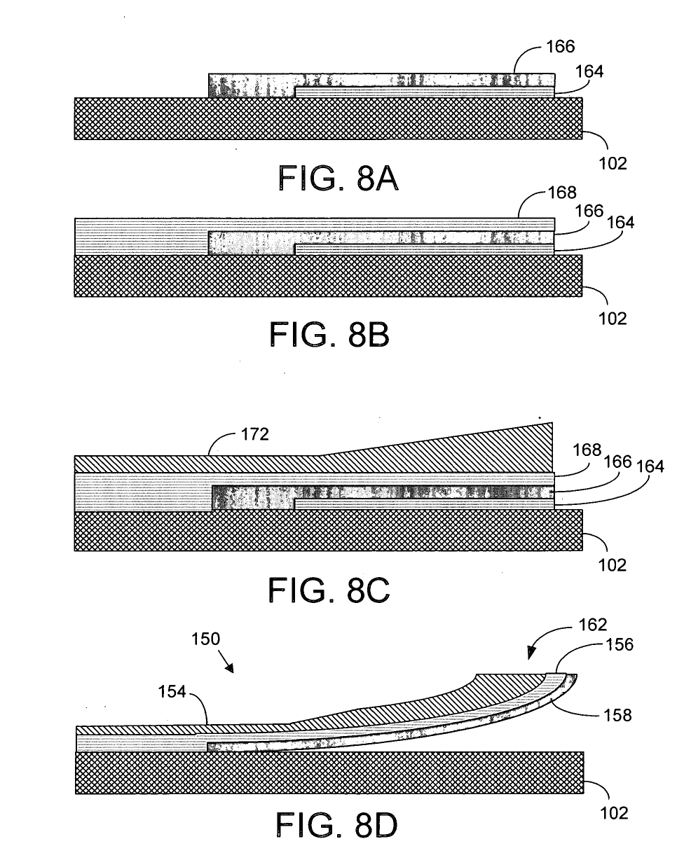

For the purposes of illustration only, and without limitation, the funnel-off-surface and curved optical waveguide 150 is described with particular reference to the below-described fabrication method. For clarity, some portions of the fabrication process are not included in FIGS. 8A through 8D. As such, the following fabrication process is not intended to be an exhaustive list that includes all steps required for fabricating the funnel-off-surface and curved optical waveguide 150. In addition, the fabrication process is flexible because the process steps may be performed in a different order than the order illustrated in FIGS. 8A through 8D.

FIGS. 8A through 8D are cross-sections of a representative embodiment of forming a funnel-shaped off-surface and curved optical waveguide 150. FIG. 8A illustrates the first substrate 102 having a metal layer 166 and a sacrificial layer 164. The sacrificial layer 164 is disposed on the first substrate 102, while the metal layer 166 is disposed on a portion of the first substrate 102 and the sacrificial layer 164. The sacrificial layer 164 and the metal layer 166 are similar (e.g., materials each are made of, fabrication thereof, and function thereof) to the corresponding components in FIGS. 1A through 1F.

FIG. 8B illustrates the formation of a cladding layer 168 on the metal layer 166 and a portion of the first substrate 102. The cladding layer 168 can be disposed using methods, such as, but not limited to, plasma enhanced chemical vapor deposition and spinning of materials. The cladding layer 168 can include materials such as those described above in reference to FIGS. 1A through 1F.

FIG. 8C illustrates the formation of the waveguide layer 172 the cladding layer 168. The waveguide layer 172 can be defined by one or more methods such as, but not limited to, photo-definition, wet chemical etching, dry plasma etching, thermally-induced refractive index gradients, and ion implantation. It should be noted that the waveguide layer 172 could be fabricated in two or more steps. For example, the tapered portion of the waveguide layer 172 can be fabricated after the planar portion of the waveguide layer 172. The two portions form a single waveguide layer 172.

FIG. 8D illustrates the formation of the funnel shaped off-surface and curved optical waveguide 150 upon the removal of the sacrificial layer 164. Once the sacrificial layer 164 is removed, the metal layer 158 curves up and away from the first substrate 102. The metal layer 158 causes the waveguide 154 to curve in substantially the same manner to form the funnel shaped off-surface and curved optical waveguide 150.

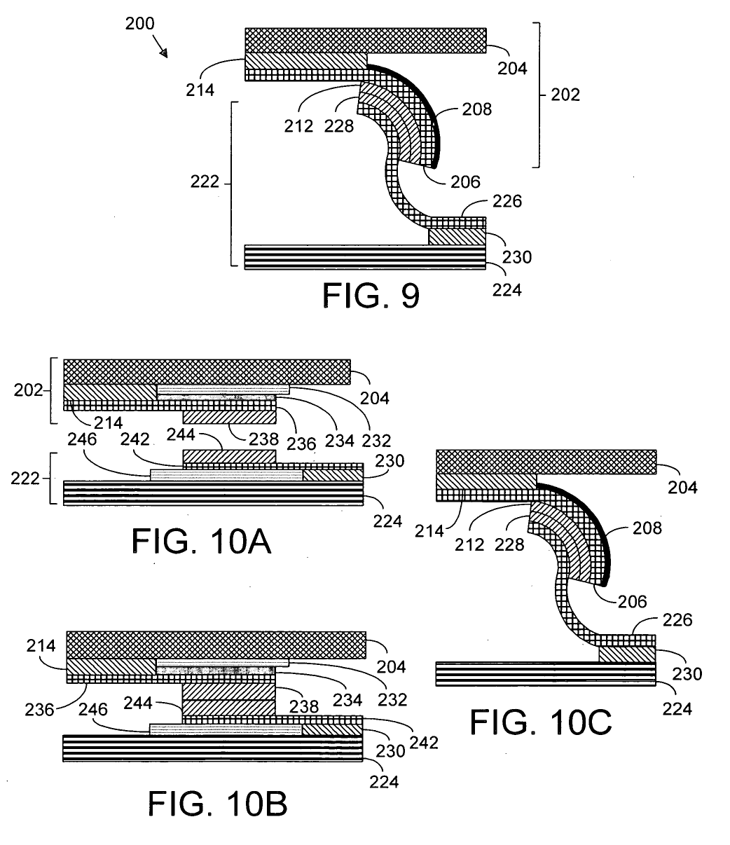

FIG. 9 is a cross-section of a representative embodiment, among others, of an optical I/O interconnect system 200 using a pair of off-surface and curved optical waveguides. The optical I/O interconnect system 200 includes a first structure 202 and a second structure 222. The first structure 202 includes a first substrate 204 having a first off-surface and curved optical waveguide 206 disposed thereon. The first off-surface and curved optical waveguide 206 has a metal layer 208 disposed on the bottom side between the first off-surface and curved optical waveguide 206 and the first substrate 204. In addition, the first off-surface and curved optical waveguide 206 includes a cladding layer 214 between the first off-surface and curved optical waveguide 206 and the first substrate 204. Furthermore, the first off-surface and curved optical waveguide 206 has a first coupler element 212 disposed on a portion of the top surface of the first off-surface and curved optical waveguide 202. It should be noted that the first coupler element 212 is substantially linear and not curved to a degree that makes the first coupler element 212 inoperable.

The second structure 222 includes a second substrate 224 having a second off-surface and curved optical waveguide 226 and a cladding layer 230 disposed thereon. The second off-surface and curved optical waveguide 226 has a second coupler element 228 disposed on a portion of the top surface of the second off-surface and curved optical waveguide 222. It should be noted that the second coupler element 228 is substantially linear and not curved to a degree that makes the first coupler element 228 inoperable.

The first substrate 204, the second substrate 224, the metal layer 208, the first off-surface and curved optical waveguide 206, the second off-surface and curved optical waveguide 226, first coupler element 212, and second coupler element 228, are similar (e.g., materials each are made of, fabrication thereof, and function thereof) to the first corresponding components described 104a-104f. In addition, the first substrate 204, the second substrate 224, the first off-surface and curved optical waveguide 206, and/or the second off-surface and curved optical waveguide 226 can include additional components such as, but not limited to, waveguides, coupling elements, optical sources/detectors, and combinations thereof.

In one embodiment, among others, the optical I/O interconnect system 200 can be used to direct optical energy from the first structure 202 to the second structure 222 and/or vice versa. For example, optical energy from components in the first substrate 204 can direct optical energy through the first off-surface and curved optical waveguide 206. The first coupler element 212 directs the optical energy towards the second coupler element 228, which guides the optical energy into the second off-surface and curved optical waveguide 226. Then the optical energy travels through the second off-surface and curved optical waveguide 226 to the second substrate 224.

It should be noted that the coupler elements 212 and 228 could be disposed within the first off-surface and curved optical waveguide 206 and the second off-surface and curved optical waveguide 226. In addition, it should be noted that a single coupler element could be used to direct optical energy between the first off-surface and curved optical waveguide 206 and the second off-surface and curved optical waveguide 226 as opposed to the use of two optical elements.

FIGS. 10A through 10C are cross-sections of a representative method, among others, for forming the optical I/O interconnect system 200 shown in FIG. 9. FIG. 10A illustrates the first structure 202 and the second structure 222. The first structure 202 includes, but is not limited to, the first substrate 204, a first sacrificial layer 232, a cladding layer 214 and a first waveguide layer 236. The first sacrificial layer 232 is disposed on a portion of the first substrate 204. A metal layer 234 is disposed on a portion of the first sacrificial layer 232. The first waveguide layer 236 is disposed on the metal layer 234 and the cladding layer 214. A first coupler element 238 is disposed on a portion of the top of the first waveguide layer 236.

The second structure 222 includes, but is not limited to, the second substrate 224, a second sacrificial layer 246, a cladding layer 230, and a second waveguide layer 242. The second sacrificial layer 246 is disposed on a portion of the second substrate 224. The second waveguide layer 242 is disposed on the cladding layer 230. A second coupler element 228 is disposed on a portion of the top of the second waveguide layer 242.

The first sacrificial layer 232, second sacrificial layer 246, first coupler element 212, second coupler element 228, cladding layer 214, cladding layer 230, and the metal layer 208 are similar (e.g., materials each are made of, fabrication thereof, and function thereof) to the corresponding components described in reference to FIGS. 1A though 1F.

FIG. 10B illustrates the first structure 202 disposed on the second structure 222. The first coupler element 238 and the second coupler element 244 are substantially aligned with one another. The first coupler element 238 and/or the second coupler element 244 can have an adhering material disposed thereon (not shown) to cause the first coupler element 238 and the second coupler element 244 to adhere to one another. The adhering material can include materials such as, but not limited to, epoxies, polymers, and combinations thereof.

FIG. 10C illustrates the formation of the first off-surface and curved optical waveguide 206 and the second off-surface and curved optical waveguide 226. Upon removal of the first sacrificial layer 232 and the second sacrificial layer 246, the metal layer 234 causes the first waveguide layer 236 to curve up and away from the first substrate 204. The first waveguide layer 236 curves in substantially the same way as the curved metal layer 208. The second waveguide layer 242 to curves in a manner that substantially compliments the curve of the curved first waveguide 206. The first sacrificial layer 232 and the second sacrificial layer 246 can be removed using techniques such as, but not limited to, wet etching, dry etching, photoimaging, molding, heating, deomposition, and combinations thereof.

As mentioned above, the removal (release) of the sacrificial material is used to separate the first substrate 204 from a second substrate 224. In other words, two parallel flat substrates that are bonded to one another can be separated by releasing the sacrificial material.

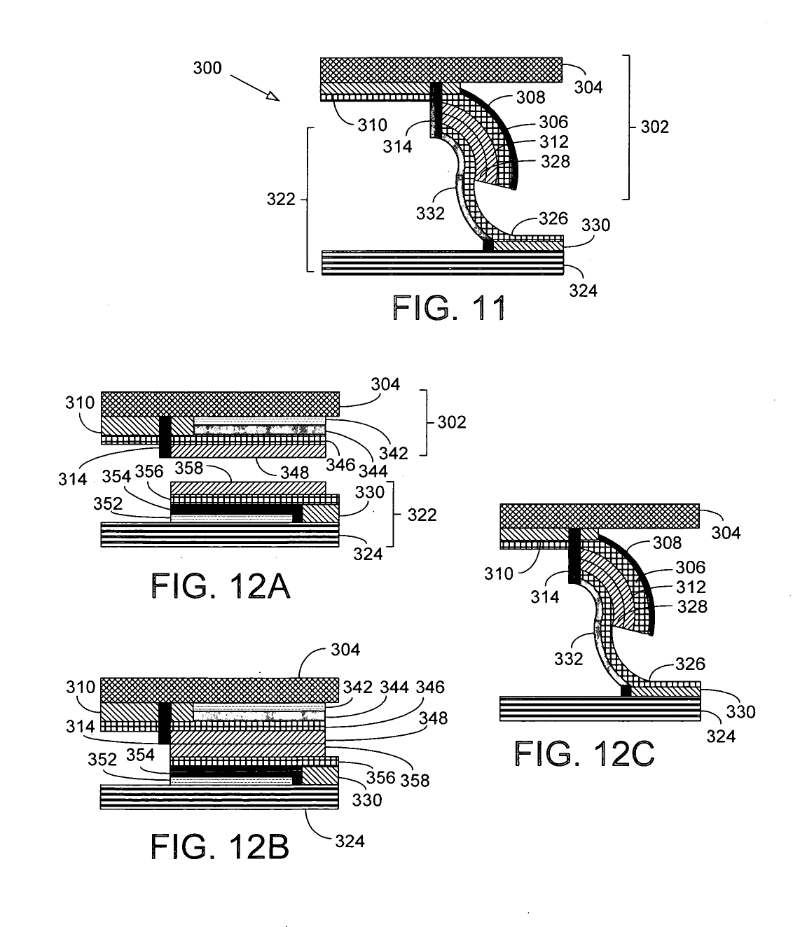

FIG. 11 is a cross-section of a representative embodiment, among others, of a dual optical/electrical I/O interconnect system 300 using a pair of off-surface and curved optical waveguides. The optical/electrical I/O interconnect system 300 includes a first structure 302 and a second structure 322. The first structure 302 includes a first substrate 304 having a first off-surface and curved optical waveguide 306 disposed and a cladding layer 310 disposed thereon. The first off-surface and curved optical waveguide 306 has a first metal layer 308 disposed on the bottom side between the first off-surface and curved optical waveguide 306 and the first substrate 304. The first off-surface and curved optical waveguide 306 has a first coupler element 312 disposed on a portion of the top surface of the first off-surface and curved optical waveguide 306. In addition, a metal lead 314 is disposed on the first substrate 304 adjacent the first off-surface and curved optical waveguide 306 and the first coupler element 312. The cross-section shown in FIG. 11 shows that the metal lead 314 cuts through the first off-surface and curved optical waveguide 306 and the cladding layer 310, but this is does to show that the metal lead 314 connects with the first substrate 304 and the first off-surface and curved optical waveguide 306 and the cladding layer 310 are continuous. In addition, it should be noted that the first coupler element 312 is substantially linear and not curved to a degree that makes the first coupler element 312 inoperable.

The second structure 322 includes a second substrate 324 having a second off-surface and curved optical waveguide 326 and a cladding layer 330 disposed thereon. The second off-surface and curved optical waveguide 326 has a second metal layer 332 disposed on the bottom side between the second off-surface and curved optical waveguide 326 and the second substrate 324. The second off-surface and curved optical waveguide 326 has a second coupler element 328 disposed on a portion of the top surface of the second off-surface and curved optical waveguide 326. It should be noted that the second coupler element 328 is substantially linear and not curved to a degree that makes the second coupler element 328 inoperable.

The first substrate 304, the second substrate 324, the first metal layer 308, the second metal layer 332, the first off-surface and curved optical waveguide 306, the second off-surface and curved optical waveguide 326, the cladding layer 310, the cladding layer 330, the first coupler element 312, and the second coupler element 328 are similar (e.g., materials each are made of, fabrication thereof, and function thereof) to the corresponding components described in reference to FIGS. 1A though 1F. In addition, the first substrate 304, the second substrate 324, the first off-surface and curved optical waveguide 306, and/or the second waveguide 326 can include additional components such as, but not limited to, waveguides, coupling elements, optical sources/detectors, and combinations thereof.

In one embodiment, among others, the optical/electrical I/O interconnect system 300 can be used to direct optical energy from the first structure 302 to the second structure 322 and/or vice versa. For example, optical energy from components in the first substrate 304 can direct optical energy through the first off-surface and curved optical waveguide 306. The first coupler element 312 directs the optical energy towards the second coupler element 328, which guides the optical energy into the second off-surface and curved optical waveguide 326. Then the optical energy travels through the second off-surface and curved optical waveguide 326 to the second substrate 324.

In addition, the optical/electrical I/O interconnect system 300 can be used as an electrical interconnection. The metal lead 314 on the first substrate 304 is electrically coupled with the metal layer 332 on the second off-surface and curved optical waveguide 326. Therefore, electrical energy from the first substrate 304 can be communicated to the second substrate 324 and/or vise versa through the optical/electrical I/O interconnect system 300. Therefore, the optical/electrical I/O interconnect system 300 is capable of optical and/or electrical interconnection. This is advantageous because one I/O can be used to accomplish optical and electrical interconnection as opposed to two I/O interconnections, which allows more I/O interconnections to be formed on a substrate.

FIGS. 12A through 12C are cross-sections of a representative method, among others, for forming the optical/electrical I/O interconnect system 300 shown in FIG. 11. FIG. 12A illustrates the first structure 302 and the second structure 322. The first structure 302 includes, but is not limited to, the first substrate 304, a first sacrificial layer 342, a cladding layer 310, and a first waveguide layer 346. The first sacrificial layer 342 is disposed on a portion of the first substrate 304. A metal layer 344 is disposed on a portion of the first sacrificial layer 342. The first waveguide layer 346 is disposed on the metal layer 344 and the cladding layer 310. A first coupler element 348 is disposed on a portion of the top of the first waveguide layer 346. In addition, the metal lead 314 is disposed on the first substrate 304 adjacent the first waveguide layer 346 and the first coupler element 348.

The second structure 322 includes, but is not limited to, the second substrate 324, a second sacrificial layer 352, a cladding layer 330, and a second waveguide layer 356. The second sacrificial layer 352 is disposed on the cladding layer 330. The second waveguide layer 356 has a second metal layer 354 disposed on the bottom side between the second waveguide layer 356 and the second sacrificial layer 352. The second waveguide layer 356 is disposed on a portion of the second substrate 324 and second metal layer 354. The second coupler element 358 is disposed on a portion of the top of the second waveguide layer 356. The second metal layer 354 may or may not be a stressed metal layer.

The first sacrificial layer 342, second sacrificial layer 352, first coupler element 348, second coupler element 358, the first metal layer 344, the second metal layer 354, the first waveguide layer 346, and the second waveguide layer 356, are similar (e.g., materials each are made of, fabrication thereof, and function thereof) to the corresponding components described in reference to FIGS. 1A though 1F.

FIG. 12B illustrates the first structure 302 disposed on the second structure 322. The first coupler element 348 and the second coupler element 358 are substantially aligned with one another. The first coupler element 348 and/or the second coupler element 358 can have an adhering material, similar to the adhering material described above, disposed thereon (not shown) to cause the first coupler element 348 and the second coupler element 358 to adhere to one another.

FIG. 12C illustrates the formation of the first off-surface and curved optical waveguide 306 and the second off-surface and curved optical waveguide 326. Upon removal of the first sacrificial layer 342 and the second sacrificial layer 352, the first metal layer 344 causes the first waveguide layer 346 to curve up and away from the first substrate 304. The first off-surface and curved optical waveguide layer 346 curves in substantially the same way as the curved metal layer 308. The second off-surface and curved optical waveguide 326 and the second metal layer 332 curve in a manner that substantially compliments to the curve of the first off-surface and curved optical waveguide 306. The second metal layer 354 comes into contact with the metal lead 314 on the first substrate 304 to form an electrical connection. The first sacrificial layer 342 and the second sacrificial layer 352 can be removed using techniques such as, but not limited to, wet etching, dry etching, photoimaging, molding, heating, deomposition, and combinations thereof.

As mentioned above, the removal (release) of the sacrificial material is used to separate the first substrate 304 from a second substrate 324. In other words, two parallel flat substrates that are bonded to one another can be separated by releasing the sacrificial material.

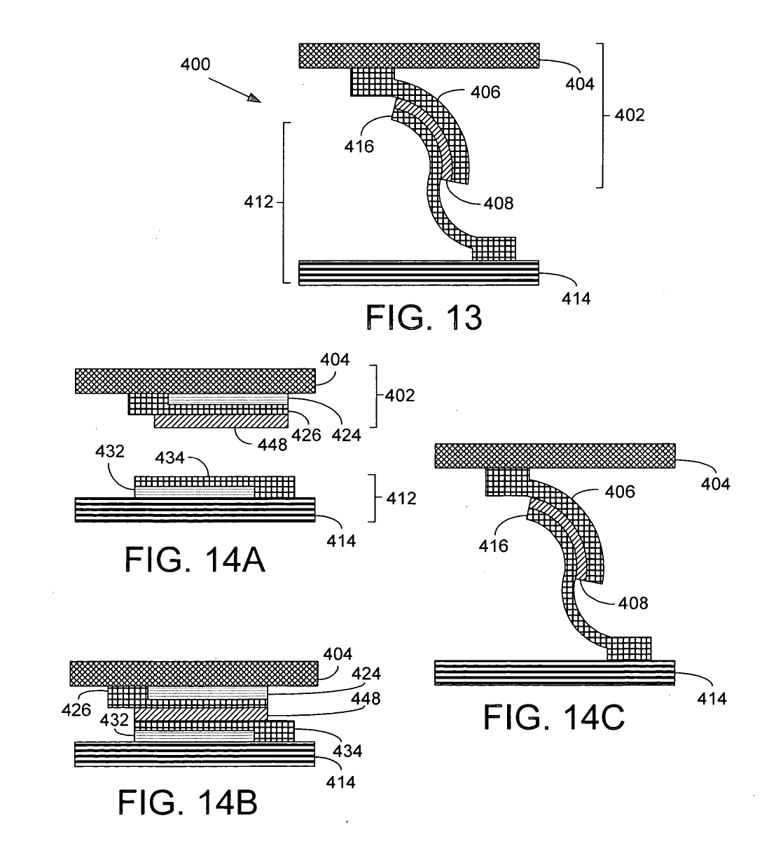

FIG. 13 is a cross-section of a representative embodiment, among others, of a radio frequency (RF) I/O interconnect system 400 using a pair of curved metal leads. The RF I/O interconnect system 400 can be used for high-frequency signal distribution. Alternatively, the radio frequency (RF) I/O interconnect system 400 can also be used a capacitor for dc power distribution power distribution and to minimize simultaneous switching noise as well calibrate RF signals. The RF I/O interconnect system 400 includes a first structure 402 and a second structure 412. The first structure 402 includes a first substrate 404 having a first curved metal lead 406 disposed thereon. The first curved metal lead 406 has a capacitive coupler layer 408 (e.g., high-k) material disposed on a portion of the top surface of the first curved metal lead 406. The second structure 412 includes a second substrate 414 having a second curved metal lead 416 disposed thereon. The first curved metal lead 406 includes a stressed metal, while the second curved metal lead 416 is not a stressed metal.

The capacitive coupler layer 408 can be formed from materials such as, but not limited to, high-k materials, low-k (for embodiment needing a small capacitance), and combinations thereof. The first substrate 404 and the second substrate 414 are similar to the first substrate 102 described in reference to FIGS. 1A though 1F.

FIGS. 14A through 14C are cross-sections of a representative method, among others, for forming the RF I/O interconnect system 400 shown in FIG. 13. FIG. 14A illustrates the first structure 402 and the second structure 412. The first structure 402 includes, but is not limited to, the first substrate 404, a first sacrificial layer 424, and a first metal lead 426. The first sacrificial layer 424 is disposed on a portion of the first substrate 404. The first metal lead 426 is disposed on the first sacrificial layer 424. A capacitive coupler layer material 428 is disposed on a portion of the top of the first metal lead 426.

The second structure 412 includes, but is not limited to, the second substrate 414, a second sacrificial layer 432, and a second metal lead 434. The second sacrificial layer 432 is disposed on a portion of the second substrate 414. The second metal lead 434 is disposed on a portion of the second substrate 414.

The first sacrificial layer 424, the second sacrificial layer 432, the first metal lead 426, and second metal lead 434 are similar (e.g., materials each are made of, fabrication thereof, and function thereof) to the corresponding components described in reference to FIGS. 1A though 1F. FIG. 14B illustrates the first structure 402 disposed on the second structure 412. The capacitive coupler layer material 448 and the second metal layer 434 are substantially aligned with one another. The capacitive coupler layer material 448 and/or the second metal lead 434 can have an adhering material disposed thereon (not shown) to cause the capacitive coupler layer material 448 and the second metal lead 434 to adhere to one another. The adhering material can include materials such as, but not limited to, epoxies, adhesives, copper-to-copper bonding, and combinations thereof.

FIG. 14C illustrates the formation of the first curved metal lead 406 and the second curved metal lead 416. Upon removal of the first sacrificial layer 424 and the second sacrificial layer 432, the first metal lead 426 curves up and away from the first substrate 404. The second metal lead 434 curves in a manner that substantially compliments the curve of the first curved metal lead 416. The first sacrificial layer 424 and the second sacrificial layer 432 can be removed using techniques such as, but not limited to, wet etching, dry etching, photoimaging, molding, heating, deomposition, and combinations thereof.

As mentioned above, the removal (release) of the sacrificial material is used to separate the first substrate 404 from a second substrate 414. In other words, two parallel flat substrates that are bonded to one another can be separated by releasing the sacrificial material.

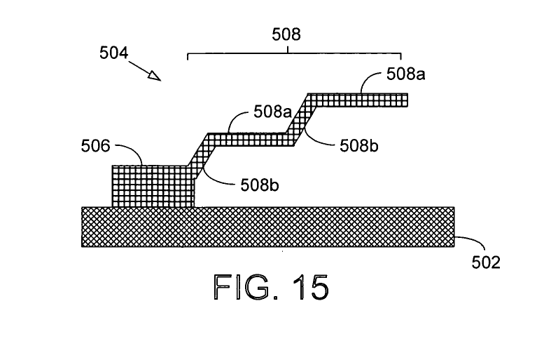

FIG. 15 is a cross-section of a representative embodiment, among others, of a multi-tiered off-surface and curved electrical lead 504 disposed on a first substrate 502. The multi-tiered off-surface and curved electrical lead 504 includes a base portion 506 that is disposed on the first substrate 502. The multi-tiered off-surface and curved electrical lead 504 includes an elevated portion 508 that curves up and away from the first substrate 502. The elevated portion 508 includes two waveguide structures 508a that are parallel to the first substrate 502 and two waveguide structures 508b that curve up and away from the first substrate 502.

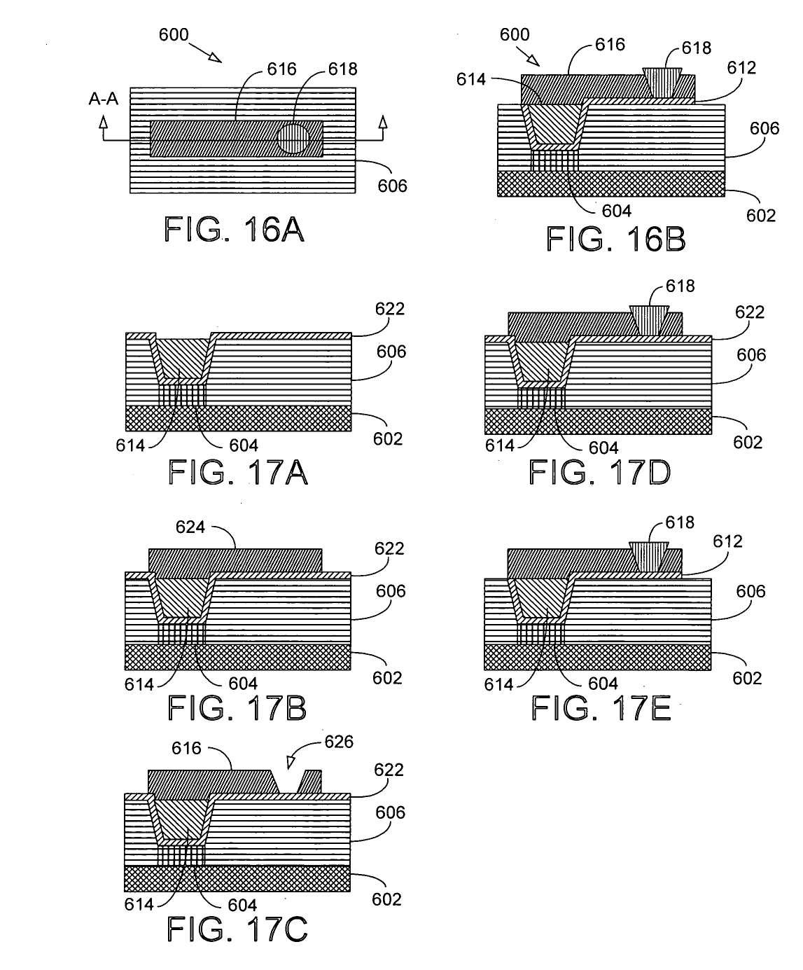

FIG. 16A is a top view of a structure 600 having a representative polymer backbone lead, while FIG. 16B is a cross-section of the structure 600 through the A-A cross-section shown in FIG. 16B. The structure 600 includes, a first substrate 602, a die pad 604, an overcoat polymer layer 606, a lead 612, a via filler 614, a polymer backbone layer 616, and a lead contact 618. The first substrate 602 has a die pad 604 disposed thereon. In addition, the overcoat polymer layer 606 is disposed on a portion of the first substrate 602. A metal lead 612 is disposed on the overcoat polymer layer 606 and the die pad 604, while the via filler 614 is disposed on the metal lead 612 in an area above the die pad 604. The lead contact 618 is disposed in a via 626 in the polymer backbone layer 616. The polymer backbone lead includes the metal lead 612, the via filler 614, the polymer backbone layer 616, and the lead contact 618.

During fabrication of the polymer backbone lead, the via 626 receives and holds the lead contact material, which can make electrical contact to underlying surface.

In another embodiment, among others, polymer backbone layer is disposed only on a portion of the lead adjacent the via. In still another embodiment, among others, the structure 600 can be fabricated so that the polymer backbone lead is disposed above the overcoat polymer layer 606. This can be accomplished by forming a sacrificial layer between the overcoat polymer layer 606 and the metal lead 612. Subsequently, the sacrificial layer is removed and the polymer backbone lead is disposed above the overcoat polymer layer 606. The polymer backbone lead is compliant because the metal lead 612 is formed of a thin metal layer (1-5 μm), which is more compliant than if the metal lead 612 was as thick as it is normally (10-20 μm). The polymer backbone layer adds strength to the metal lead 612, while also being compliant. In another embodiment, the metal lead 612 can be designed to have very small electrical parasitics.

An alternative to purely metallic leads is the polymer backbone lead. The polymer backbone of the polymer backbone lead provides a convenient non-wettable solder surface. In addition, such leads have lower stiffness and provide higher compliance than purely metallic leads of the same thickness. In particular, the Young's modulus of Au (about 80 GPa) is approximately 160 times greater than that of the Avatrel 2000P polymer (about 0.5 GPa). As the thickness of a metallic lead increases, the lead becomes stiffer and thus, less mechanically compliant. As a result, it is desirable to have thin metallic leads that provide higher compliance. However, it is highly unlikely that a chip with 1 μm or 2 μm thick leads would be very reliable. The leads would be very susceptible to any shear stress. As a result, it becomes important to provide the thin and highly compliant leads with higher mechanical stability. High mechanical stability can be attained by fabricating thick leads. However, a 2 μm thick Au lead is expected to provide higher compliance than a 10 μm thick Au lead. As a result, the trade off here is compliance versus mechanical integrity and reliability. However, by using a polymer backbone to enhance the mechanical integrity of the thin leads, no such tradeoff is foreseen. This is because the metallic film with the two orders of magnitude higher modulus will dictate the mechanical behavior of the polymer backbone lead.

The first substrate 602 is similar to the first substrate 102 described in reference to FIGS. 1A though 1F. The via filler 614 can be a material such as, but not limited to, copper, gold, nickel, composites of each, and combinations thereof. In one embodiment, the filler is included. The polymer backbone layer 616 a polymer such as, for example, polyimides, polynorborenes, epoxides, polyarylenes, ethers, parylenes, and combinations thereof. The metal lead 612 can be made of metals such as, but not limited to, Cu, Au, Ni, Cr, Sn, and combinations thereof. The lead contact 618 can be made of metals such as, but not limited to, solder, Sn/Pb, lead-free solder, conductive adhesives, and combinations thereof. The lead contact 618 can also be a metallic post used to connect to the solder on a board.

The overcoat polymer layer 606 can be a polymer such as, for example, polyimides, polynorborenes, epoxides, polyarylenes, ethers, and parylenes. The overcoat layer 606 can be deposited using any suitable technique such as, for example, spin-coating, doctor-blading, sputtering, lamination, screen or stencil-printing, chemical vapor deposition (CVD), or through plasma based deposition systems.

FIGS. 17A through 17E are cross-sections of a representative method, among others, for forming the polymer backbone lead shown in FIGS. 16A and 16B. FIG. 17A illustrates the first substrate 602 having the die pad 604 disposed thereon. In addition, the overcoat polymer layer 606 is disposed on a portion of the first substrate 602. A metal lead layer 622 is disposed on the overcoat polymer layer 606 and the die pad 604, while the via filler 614 is disposed on the metal lead layer 622 in the area above the die pad 604.

FIG. 17B illustrates the formation of the polymer backbone layer 624 on a portion of the metal lead layer 622 and the via filler 614. The polymer backbone layer 624 can be deposited using any suitable technique such as, for example, spin-coating, doctor-blading, sputtering, lamination, screen or stencil-printing, chemical vapor deposition (CVD), or through plasma based deposition systems.

FIG. 17C illustrates the formation of the via 626 on the polymer backbone layer 624. The via 626 can be formed using techniques such as, but not limited to, wet/dry etching. It should be noted that the steps in FIGS. 17B and 17C can be performed simultaneously.

FIG. 17D illustrates the removal of the metal lead layer 622 that is not covered by the polymer backbone layer 616, while FIG. 17E illustrates the structure 600 after the metal lead layer 622 has been removed. The metal lead layer 622 can be removed using techniques such as, but not limited to, wet etching and dry etching.

It should be emphasized that the above-described embodiments of the present invention are merely possible examples of implementations, and are set forth for a clear understanding of the principles of the invention. Many variations and modifications may be made to the above-described embodiments of the invention without departing substantially from the spirit and principles of the invention. For example, in reference to FIGS. 1A through 1F there might be the need to make a release window in order to remove the sacrificial material without causing the whole lead to delaminate. All such modifications and variations are intended to be included herein within the scope of this disclosure and the present invention and protected by the following claims.

Therefore, having thus described the invention, at least the following is claimed:

1. A waveguide system, comprising:
a first substrate having an off-surface and curved optical waveguide disposed thereon, wherein the off-surface and curved optical waveguide includes a first portion and a second portion, wherein the first portion is substantially parallel to the first substrate, wherein the second portion extends curving away from the first substrate, wherein the first portion has a first end, a second end, a length, a width, and a thickness, wherein the second portion has a first end, a second end, a length, a width and a thickness, wherein the second end of the first portion is substantially adjacent and in-line with the first end of the second portion, wherein the first portion comprises an optically conductive first material, and wherein the first portion comprises an optically conductive second material.

2. The waveguide system of claim 1, wherein the optically conductive first material comprises a low modulus material selected from polyimides, epoxide, polynorbornenes, polyarylene ethers, and parylenes.

3. The waveguide system of claim 1, wherein the optically conductive second material comprises a low modulus material selected from polyimides, epoxide, polynorbornenes, polyarylene ethers, and parylenes.

4. The waveguide system of claim 1, wherein the optically conductive first material and the optically conductive second material are the same material.

5. The waveguide system of claim 1, wherein the optically conductive first material and the optically conductive second material are different materials.

6. The waveguide system of claim 1, wherein the first portion and the second portion have substantially the same thickness and width.

7. The waveguide system of claim 1, wherein the second end of the first portion and the first end of the second portion each have the same width, and wherein the width of the second portion expands wider from the first end to the second end.

8. The waveguide system of claim 1, wherein the second end of the first portion and the first end of the second portion each have the same thickness, and wherein the thickness of the second portion expands thicker from the first end to the second end.

9. The waveguide system of claim 1, wherein the width of the second portion expands wider from the first end to the second end and wherein the thickness of the second portion expands thicker from the first end to the second end.

10. The I/O interconnect system of claim 1, wherein the second end of the second portion forms a “Y”-shape, wherein the second end of the second portion has two off-surface and curved optical waveguide tips.

11. The waveguide system of claim 1, wherein the second portion is tapered in thickness from the second end to the first end.

12. The waveguide system of claim 1, wherein the second portion is tapered in width from the second end to the first end.

13. The waveguide system of claim 1, wherein the second portion is tapered in thickness from the second end to the first end and wherein the second portion is tapered in width from the second end to the first end.

14. The waveguide system of claim 13, further comprising at least one second layer disposed adjacent to a least a portion of the off-surface and curved optical waveguide.

15. The waveguide system of claim 14, wherein the second layer is substantially disposed between the off-surface and curved optical waveguide and the first substrate, and wherein the second layer is curved like the off-surface and curved optical waveguide.

16. The waveguide system of claim 14, wherein the second layer is substantially disposed on the off-surface and curved optical waveguide on the side opposite the first substrate, and wherein the second layer is curved like the off-surface and curved optical waveguide.

17. The waveguide system of claim 14, wherein the at least one second layer is selected from a waveguide cladding layer, an optical coupler layer, a capacitive coupler layer, a metal layer, and combinations thereof.

18. The waveguide system of claim 14, wherein the at least one second layer is selected from an electrical lead, a radio frequency lead, and combinations thereof.

19. The waveguide system of claim 1, wherein the first substrate has from about 1 off-surface and curved optical waveguide to about 500,000 off-surface and curved optical waveguides per centimeter squared of the first substrate.

20. The waveguide system of claim 1, wherein the off-surface and curved optical waveguide has a height of about 10 to 500 micrometers.

21. The waveguide system of claim 1, wherein the off-surface and curved optical waveguide has a thickness of about 0.1 to 500 micrometers and a width of about 0.1 to 500 micrometer.

22. The waveguide system of claim 1, further comprising:
a second substrate having at least one element adapted to receive the off-surface and curved optical waveguide.

23. The waveguide system of claim 1, wherein the second portion includes at least one portion substantially parallel to the first substrate and at least one portion curving away from the first substrate.

24. The waveguide system of claim 1, wherein the off-surface and curved optical waveguide is included in a distribution system selected from a clock distribution system and signal distribution system.

25. The waveguide system of claim 1, wherein the off-surface and curved optical waveguide is included in a microelectronic device.

26. The waveguide system of claim 1, wherein the off-surface and curved optical waveguide is included in a integrated optical device.

27. A method of directing optical energy, comprising:
providing a first substrate having an off-surface and curved optical waveguide disposed thereon, wherein the off-surface and curved optical waveguide includes a first portion and a second portion, wherein the first portion is substantially parallel to the first substrate, wherein the second portion extends curving away from the first substrate; and
communicating optical energy through the first off-surface and curved optical waveguide.

28. The method of claim 27, further comprising:
providing a second substrate having at least one element adapted to receive the off-surface and curved optical waveguide; and
communicating optical energy through the first off-surface and curved optical waveguide of the first substrate to the at least one element of the second substrate.

29. An input/output (I/O) interconnect system, comprising:
a first substrate having a first off-surface and curved optical waveguide disposed thereon, wherein the first off-surface and curved optical waveguide includes a first portion and a second portion, wherein the first portion is substantially parallel to the first substrate, wherein the second portion extends curving away from the first substrate, wherein the second portion has a coupler layer selected from an optical coupler layer and a capacitive coupler layer, disposed on the second portion, wherein the coupler layer is curved substantially the same as the first off-surface and curved optical waveguide;
a second substrate having a second off-surface and curved optical waveguide disposed thereon, wherein the second off-surface and curved optical waveguide includes a first portion and a second portion, wherein the first portion is substantially parallel to the first substrate, wherein the second portion extends curving away from the first substrate, wherein the second portion has a coupler layer selected from a optical coupler layer and a capacitive coupler layer, disposed on the second portion, wherein the coupler layer is curved substantially the same as the second off-surface and curved optical waveguide; and
wherein a top surface of the coupler layer of the first substrate and a top surface of the coupler layer of the second substrate are disposed adjacent one another and are communicatively coupled.

30. The I/O interconnect system of claim 29, wherein the first substrate includes a curved electrical lead disposed on a bottom side of the first off-surface and curved optical waveguide between a portion of the first off-surface and curved optical waveguide and the first substrate, wherein the second substrate includes an electrical lead disposed on an area of the second substrate adjacent the second off-surface and curved optical waveguide, wherein the curved electrical lead of the first substrate and the electrical lead of the second substrate are disposed adjacent one another and are communicatively coupled.

31. The I/O interconnect system of claim 29, wherein the first off-surface and curved optical waveguide includes at least one second layer selected from a waveguide cladding layer, a metal layer, and combinations thereof.

32. The I/O interconnect system of claim 29, wherein the second off-surface and curved optical waveguide includes at least one second layer selected from a waveguide cladding layer, a metal layer, and combinations thereof.

33. A method of directing energy, comprising:
providing a first substrate having a first off-surface and curved optical waveguide disposed thereon, wherein the first off-surface and curved optical waveguide includes a first portion and a second portion, wherein the first portion is substantially parallel to the first substrate, wherein the second portion extends curving away from the first substrate, wherein the second portion has a coupler layer selected from an optical coupler layer and a capacitive coupler layer, disposed on the second portion, wherein the coupler layer is curved substantially the same as the first off-surface and curved optical waveguide;
providing a second substrate having a second off-surface and curved optical waveguide disposed thereon, wherein the second off-surface and curved optical waveguide includes a first portion and a second portion, wherein the first portion is substantially parallel to the first substrate, wherein the second portion extends curving away from the first substrate, wherein the second portion has a coupler layer selected from an optical coupler layer and a capacitive coupler layer, disposed on the second portion, wherein the coupler layer is curved substantially the same as the second off-surface and curved optical waveguide, wherein a top surface of the coupler layer of the first substrate and a top surface of the coupler layer of the second substrate are disposed adjacent one another and are communicatively coupled; and
communicating optical energy through the first off-surface and curved optical waveguide of the first substrate and the second off-surface and curved optical waveguide of the second substrate.

34. The method of directing energy of claim 33, wherein the first substrate includes an electrical lead disposed on a bottom side of the first off-surface and curved optical waveguide between a portion of the first off-surface and curved optical waveguide and the first substrate, wherein the second substrate includes an electrical lead disposed on an area of the second substrate adjacent the second off-surface and curved optical waveguide, wherein the electrical lead of the first substrate and the electrical lead of the second substrate are disposed adjacent one another and are communicatively coupled; and further comprising:
communicating electrical energy through the electrical lead of the first substrate to the electrical lead contact of the second substrate.

35. A method for fabricating an off-surface and curved optical waveguide comprising:
providing a substrate;
disposing a sacrificial material onto at least one portion of the substrate;
disposing a stressed metal material onto a portion of the sacrificial material and a portion of the substrate;
disposing a waveguide material onto a portion of the stressed metal material; and
removing the sacrificial material.

36. A method for fabricating an off-surface and curved optical waveguide comprising:
providing a substrate;
disposing a sacrificial material on at least one portion of the substrate;
disposing a waveguide material on a portion of the sacrificial material and a portion of the substrate;
disposing a stressed metal material on a portion of the first material; and
removing the sacrificial layer.

37. A method for fabricating an off-surface and curved optical waveguide comprising:
providing a substrate;
disposing a waveguide material on a curved mold and a portion of the substrate; and
removing the mold.

38. A method of aligning substrates, comprising:
providing a first substrate having an off-surface and curved optical waveguide disposed thereon, wherein the off-surface and curved optical waveguide includes a first portion and a second portion, wherein the first portion is substantially parallel to the first substrate, wherein the second portion extends curving away from the first substrate, wherein the first portion has a first end, a second end, a length, a width, and a thickness, wherein the second portion has a first end, a second end, a length, a width and a thickness, wherein the second end of the first portion is substantially adjacent and in-line with the first end of the second portion, wherein the first portion comprises an optically conductive first material, wherein the first portion comprises an optically conductive second material, and wherein the first substrate has a first coefficient of thermal expansion; and
providing a second substrate having an optical element and having a second coefficient of thermal expansion, wherein the first coefficient of thermal expansion is different than the second coefficient of thermal expansion;
maintaining optical alignment between the first substrate and the second substrate.

39. A method of separating two microelectronic substrates, comprising:
providing a first substrate having a sacrificial layer disposed on the first substrate, a stressed metal layer disposed on the sacrificial layer, and a structure disposed on the stressed metal layer;
providing a second substrate, wherein the first substrate and the second substrate are bonded to one another on at least on position;
assembling the first and second substrate; and
removing the sacrificial layer, wherein upon removal of the sacrificial layer the stressed metal layer causes the structure to curve away from the first substrate and the movement of the structure causes the first substrate to move away from the second substrate.
